(19) United States
(12) Patent Application Publication
(10) Pub. No.: US 2025/0202064 A1
(43) Pub. Date: Jun. 19, 2025

(54) LAMINATED SEPARATOR FOR NONAQUEOUS ELECTROLYTE SECONDARY BATTERY

(71) Applicant: Sumitomo Chemical Company, Limited, Tokyo (JP)

(72) Inventors: Riku MATSUMINE, Niihama-shi (JP); Tomoaki Ozeki, Niihama-shi (JP)

(21) Appl. No.: 18/978,712

(22) Filed: Dec. 12, 2024

(30) Foreign Application Priority Data
Dec. 14, 2023 (JP) 2023-211515
Mar. 14, 2024 (JP) 2024-040471

(51) Int. Cl. H01M 50/489; H01M 50/417; H01M 50/423; H01M 50/449

(52) U.S. Cl. CPC H01M 50/489; H01M 50/417; H01M 50/423; H01M 50/449

(57) ABSTRACT

A laminated separator for a nonaqueous electrolyte secondary battery is provided which makes it possible to obtain a battery having an excellent rate characteristic and which has excellent heat resistance. A laminated separator for a nonaqueous electrolyte secondary battery according to the present disclosure includes a polyolefin-based substrate and a heat-resistant layer that is provided on one surface or both surfaces of the polyolefin-based substrate, the laminated separator including a particle layer which is provided on at least one side of the laminated separator, a standard deviation of surface roughness on a surface of the laminated separator which surface is located on the at least one side on which the particle layer is provided being not more than 0.06.

This Nonprovisional application claims priority under 35 U.S.C. § 119 on Patent Application No. 2023-211515 filed in Japan on Dec. 14, 2023 and Patent Application No. 2024-040471 filed in Japan on Mar. 14, 2024, the entire contents of which are hereby incorporated by reference.

### TECHNICAL FIELD

The present invention relates to a laminated separator for a nonaqueous electrolyte secondary battery.

### BACKGROUND ART

Nonaqueous electrolyte secondary batteries, particularly lithium ion secondary batteries, have a high energy density, and are therefore widely used as batteries for personal computers, mobile telephones, portable information terminals, cars, and the like.

A lithium ion battery generally includes a separator provided between a positive electrode and a negative electrode. For example, Patent Literature 1 discloses a battery separator which includes a resin porous layer and an inorganic particle layer that is formed on at least one main surface of the resin porous layer, an adhesive layer being formed on a surface of the inorganic particle layer which surface is opposite from the resin porous layer, an 85-degree specular gloss on a surface of the adhesive layer being not less than 32.

### CITATION LIST

### Patent Literature

[Patent Literature 1]
Japanese Patent Application Publication Tokukai No. 2021-180134

### SUMMARY OF INVENTION

### Technical Problem

However, a conventional technique as described above has room for improvement from the viewpoint of a rate characteristic and heat resistance. An object of an aspect of the present invention is to realize a laminated separator which is for a nonaqueous electrolyte secondary battery and which makes it possible to obtain a battery having an excellent rate characteristic and which has excellent heat resistance.

### Solution to Problem

In order to attain the above object, a laminated separator for a nonaqueous electrolyte secondary battery in accordance with an aspect of the present invention is a laminated separator which is for a nonaqueous electrolyte secondary battery and which includes a polyolefin-based substrate and a heat-resistant layer that is provided on one surface or both surfaces of the polyolefin-based substrate, the laminated separator including a particle layer which is provided on at least one side of the laminated separator, a standard deviation of surface roughness on a surface of the laminated separator which surface is located on the at least one side on which the particle layer is provided being not more than 0.06.

### Advantageous Effects of Invention

In an aspect of the present invention, it is possible to provide a laminated separator which is for a nonaqueous electrolyte secondary battery and which makes it possible to obtain a battery having an excellent rate characteristic and which has excellent heat resistance.

### BRIEF DESCRIPTION OF DRAWINGS

FIG. 1 is a drawing schematically illustrating a structure of a laminated separator for a nonaqueous electrolyte secondary battery in accordance with an embodiment of the present invention.

FIG. 2 is a drawing schematically illustrating a structure of a laminated separator for a nonaqueous electrolyte secondary battery in accordance with an embodiment of the present invention.

FIG. 3 is a drawing schematically illustrating a structure of a laminated separator for a nonaqueous electrolyte secondary battery in accordance with an embodiment of the present invention.

FIG. 4 is a drawing schematically illustrating a structure of a laminated separator for a nonaqueous electrolyte secondary battery in accordance with an embodiment of the present invention.

FIG. 5 is a drawing schematically illustrating a structure of a laminated separator for a nonaqueous electrolyte secondary battery in accordance with an embodiment of the present invention.

### DESCRIPTION OF EMBODIMENTS

The following description will discuss embodiments of the present invention. The present invention is, however, not limited to the embodiments below. Any numerical range expressed as “A to B” herein means “not less than A and not more than B” unless otherwise stated.

### [1. Laminated Separator for Nonaqueous Electrolyte Secondary Battery]

### Embodiment 1

A laminated separator for a nonaqueous electrolyte secondary battery in accordance with Embodiment 1 is a laminated separator which is for a nonaqueous electrolyte secondary battery and which includes a polyolefin-based substrate and a heat-resistant layer that is provided on one surface or both surfaces of the polyolefin-based substrate, the laminated separator including a particle layer which is provided on at least one side of the laminated separator, a standard deviation of a 60-degree specular gloss on a surface of the laminated separator which surface is located on the at least one side on which the particle layer is provided being not more than 0.80. Hereinafter, the laminated separator for a nonaqueous electrolyte secondary battery is also simply referred to as “laminated separator”.

The inventors of the present invention conducted diligent studies, and found it possible to provide a laminated separator which makes it possible to obtain a battery having an excellent rate characteristic and which has excellent heat resistance, by controlling not a mere specular gloss but the standard deviation of the specular gloss on a surface of the laminated separator which surface is located on a side on which a particle layer is provided. As a reason why such a laminated separator is obtained, a mechanism as follows is inferred. It is considered that, in a laminated separator in which the standard deviation of a specular gloss is controlled as described above, a distribution of particles in an in-plane direction and a distribution of particles in a thickness direction are uniformly controlled. It is considered that, since such a laminated separator can be prevented from being ununiformly deformed even in a case where the laminated separator is compressed in a battery and, therefore, an ununiform reaction during charge and discharge can be prevented, a rate characteristic is improved. Moreover, the laminated separator can be uniformly bonded to an electrode. Therefore, it is considered that, even in a case where damage occurs, the damage can be prevented from expanding due to heat, because the laminated separator is uniformly supported by the electrode.

In the present specification, the 60-degree specular gloss conforms to JIS Z8741, and means a specular gloss measured under a condition that a light-incident angle and a light-receiving angle are each 60 degrees. Hereinafter, the 60-degree specular gloss is also simply referred to as “60-degree gloss”.

The standard deviation of the 60-degree gloss is preferably not more than 0.80, more preferably not more than 0.60, and still more preferably not more than 0.55. The smaller the standard deviation of the 60-degree gloss is, the more preferable it is. The lower limit of the standard deviation of the 60-degree gloss may be, for example, not less than 0.10. The lower limit of the average value of the 60-degree gloss is preferably not less than 2.0, and more preferably not less than 2.5. The upper limit of the average value of the 60-degree gloss may be not more than 9.0, or may be not more than 8.0.

In the present specification, an 85-degree specular gloss conforms to JIS Z8741, and means a specular gloss measured under a condition that a light-incident angle and a light-receiving angle are each 85 degrees. Hereinafter, the 85-degree specular gloss is also simply referred to as “85-degree gloss”.

The standard deviation of the 85-degree gloss on the surface of the laminated separator which surface is located on the at least one side on which the particle layer is provided is preferably not more than 3.0, and more preferably not more than 2.5. The smaller the standard deviation of the 85-degree gloss is, the more preferable it is. The lower limit of the standard deviation of the 85-degree gloss may be, for example, not less than 0.10. The lower limit of the average value of the 85-degree gloss is preferably not less than 10, and more preferably not less than 15. The upper limit of the average value of the 85-degree gloss may be not more than 30, or may be not more than 25.

### <1.1. Configurations of Laminated Separator>

In the laminated separator, the particle layer may be provided at the surface of the laminated separator, or another layer may be further provided on the particle layer. The following will specifically discuss configurations of the laminated separator with reference to FIGS. 1 to 5.

As shown in FIG. 1, in an embodiment, a laminated separator 4a includes a polyolefin-based substrate 1, heat-resistant layers 2a and 2b which are provided on both surfaces of the polyolefin-based substrate 1, and particle layers 3a and 3b which are provided at surfaces on both sides of the laminated separator 4a.

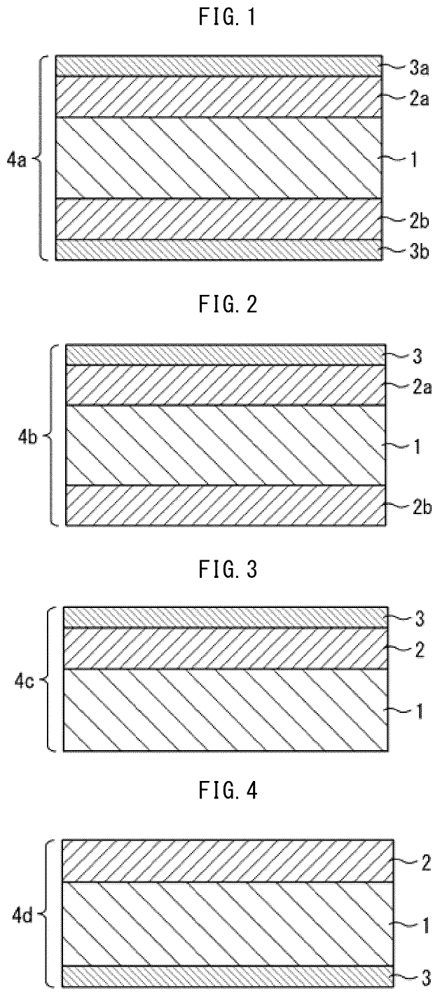

Further, as shown in FIG. 2, in an embodiment, a laminated separator 4b includes a polyolefin-based substrate 1, heat-resistant layers 2a and 2b which are provided on both surfaces of the polyolefin-based substrate 1, and a particle layer 3 which is provided at a surface on one side of the laminated separator 4b.

Further, as shown in FIG. 3, in an embodiment, a laminated separator 4c includes a polyolefin-based substrate 1, a heat-resistant layer 2 which is provided on one surface of the polyolefin-based substrate 1, and a particle layer 3 which is provided at a surface of the laminated separator 4c on a side where the heat-resistant layer 2 is provided.

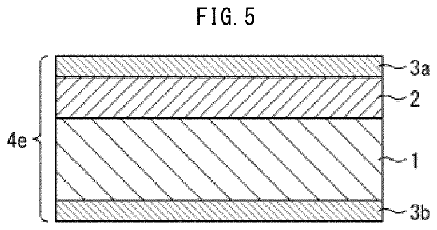

In addition to the above configurations, as shown in FIG. 4, in an embodiment, a laminated separator 4d includes a polyolefin-based substrate 1, a heat-resistant layer 2 which is provided on one surface of the polyolefin-based substrate 1, and a particle layer 3 which is provided at a surface of the laminated separator 4d on a side where no heat-resistant layer is provided.

Further, in addition to the above configurations, as shown in FIG. 5, in an embodiment, a laminated separator 4e includes a polyolefin-based substrate 1, a heat-resistant layer 2 which is provided on one surface of the polyolefin-based substrate 1, and particle layers 3a and 3b which are provided at surfaces on both sides of the laminated separator 4e.

### <1.2. Polyolefin-Based Substrate>

The laminated separator includes a polyolefin-based substrate. As used herein, the term “polyolefin-based substrate” refers to a substrate that contains a polyolefin-based resin as a main component. Further, the phrase “contains a polyolefin-based resin as a main component” means that the polyolefin-based resin is contained, in the substrate, at a proportion of not less than 50% by weight, preferably not less than 90% by weight, and more preferably not less than 95% by weight with respect to all materials that constitute the substrate.

The polyolefin-based substrate contains the polyolefin-based resin as a main component, and has therein many pores connected to one another. This allows gas and liquid to pass through the polyolefin-based substrate from one surface to the other. Note that, hereinafter, the polyolefin-based substrate is also simply referred to as “substrate”.

The polyolefin-based resin preferably contains a high molecular weight component having a weight-average molecular weight of 5×10⁵ to 15×10⁶. In particular, the polyolefin-based resin more preferably contains a high molecular weight component having a weight-average molecular weight of not less than 1,000,000 because the strength of the laminated separator improves.

Examples of the polyolefin-based resin include homopolymers and copolymers which are each obtained by polymerizing a monomer(s) such as ethylene, propylene, 1-butene, 4-methyl-1-pentene, and/or 1-hexene. Examples of such homopolymers include polyethylene, polypropylene, and polybutene. Examples of the copolymers include an ethylene-propylene copolymer.

Among the above polyolefin-based resins, polyethylene is preferable as the polyolefin-based resin because it is possible to prevent a flow of an excessively large electric current at a lower temperature. Note that the phrase “to prevent a flow of an excessively large electric current” is also referred to as “shutdown”. Examples of the polyethylene include low-density polyethylene, high-density polyethylene, linear polyethylene (ethylene-α-olefin copolymer), and ultra-high molecular weight polyethylene having a weight-average molecular weight of not less than 1,000,000. Among these polyethylenes, ultra-high molecular weight polyethylene having a weight-average molecular weight of not less than 1,000,000 is more preferable.

The weight per unit area of the substrate can be determined as appropriate in view of strength, thickness, weight, and handleability. Note, however, that the weight per unit area of the substrate is preferably 2 g/m² to 20 g/m², more preferably 2 g/m² to 12 g/m², and still more preferably 3 g/m² to 10 g/m², so as to allow a nonaqueous electrolyte secondary battery to have a higher weight energy density and a higher volume energy density.

The substrate has an air permeability of preferably 30 s/100 mL to 500 s/100 mL, and more preferably 50 s/100 mL to 300 s/100 mL, in terms of Gurley values. It can be said that the substrate having an air permeability falling within the above range has sufficient ion permeability.

The substrate has a porosity of preferably 20% by volume to 80% by volume, and more preferably 30% by volume to 75% by volume, so as to (i) retain a larger amount of an electrolyte and (ii) obtain the function of reliably preventing a flow of an excessively large electric current at a lower temperature. Further, in order to achieve sufficient ion permeability and prevent particles from entering the positive electrode and/or the negative electrode, the substrate has pores each having a pore diameter of preferably not more than 0.3 μm, and more preferably not more than 0.14 μm.

The lower limit of the thickness of the substrate is preferably not less than 3 μm, more preferably not less than 4 μm, and still more preferably not less than 5 μm. The upper limit of the thickness of the substrate is preferably not more than 29 μm, more preferably not more than 20 μm, and still more preferably not more than 15 μm. Examples of a combination of the lower limit and the upper limit of the thickness of the substrate include 3 μm to 29 μm, 4 μm to 20 μm, and 5 μm to 15 μm.

### <1.3. Heat-Resistant Layer>

The laminated separator includes a heat-resistant layer which is provided on one surface or both surfaces of the polyolefin-based substrate. The heat-resistant layer contains a heat-resistant resin. The heat-resistant layer means a layer having a melting temperature higher than that of the substrate. The heat-resistant resin can be a resin which has a melting point or a glass transition temperature higher than that of the resin constituting the substrate. It is preferable that the resin be insoluble in the electrolyte of the battery and, when the battery is in normal use, be electrochemically stable.

Examples of the resin include: polyolefins; (meth)acrylate-based resins; aromatic resins; fluorine-containing resins; polyamide-based resins; polyimide-based resins; polyester-based resins; rubbers; resins each having a melting point or a glass transition temperature of not lower than 180° C.; water-soluble polymers; polycarbonate; polyacetal; and polyether ether ketone. Among the above resins, one or more resins selected from the group consisting of polyolefins, (meth)acrylate-based resins, fluorine-containing resins, aromatic resins, polyamide-based resins, polyester-based resins, and water-soluble polymers are preferable.

As the resin, aromatic resins are more preferable. Further, among the aromatic resins, nitrogen-containing aromatic resins are particularly preferable. Furthermore, among the nitrogen-containing aromatic resins, aramid resins (described later) are most preferable. The nitrogen-containing aromatic resins are excellent in heat resistance since the nitrogen-containing aromatic resins include a bond via nitrogen, such as an amide bond.

Preferable examples of the polyolefins include polyethylene, polypropylene, polybutene, and an ethylene-propylene copolymer.

Examples of the fluorine-containing resins include polyvinylidene fluoride (PVDF), polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer. The fluorine-containing resins are particularly exemplified by fluorine-containing rubbers each having a glass transition temperature of not higher than 23° C.

The polyamide-based resins are preferably polyamide-based resins which are nitrogen-containing aromatic resins, and particularly preferably aramid resins such as aromatic polyamides and wholly aromatic polyamides.

Examples of the aramid resins include poly(paraphenylene terephthalamide), poly(metaphenylene isophthalamide), poly(parabenzamide), poly(metabenzamide), poly(4,4′-benzanilide terephthalamide), poly(paraphenylene-4,4′-biphenylene dicarboxylic acid amide), poly(metaphenylene-4,4′-biphenylene dicarboxylic acid amide), poly(paraphenylene-2,6-naphthalene dicarboxylic acid amide), poly(metaphenylene-2,6-naphthalene dicarboxylic acid amide), poly(2-chloroparaphenylene terephthalamide), a paraphenylene terephthalamide/2,6-dichloroparaphenylene terephthalamide copolymer, a metaphenylene terephthalamide/2,6-dichloroparaphenylene terephthalamide copolymer, a paraphenylene terephthalamide/3,4′-oxydiphenylene terephthalamide copolymer, poly(4,4′-diphenylsulfonyl terephthalamide), and a paraphenylene terephthalamide/4,4′-diphenylsulfonyl terephthalamide copolymer. Among the above aramid resins, poly(paraphenylene terephthalamide) or a paraphenylene terephthalamide/4,4′-diphenylsulfonyl terephthalamide copolymer is more preferable.

The polyester-based resins are preferably aromatic polyesters such as polyarylates, and liquid crystal polyesters.

Examples of the rubbers include a styrene-butadiene copolymer and a hydride thereof, a methacrylate ester copolymer, an acrylonitrile-acrylic ester copolymer, a styrene-acrylic ester copolymer, ethylene propylene rubber, and polyvinyl acetate.

Examples of the resins each having a melting point or a glass transition temperature of not lower than 180° C. include polyphenylene ether, polysulfone, polyether sulfone, polyphenylene sulfide, polyetherimide, polyamide imide, and polyether amide.

Examples of the water-soluble polymers include polyvinyl alcohol, polyethylene glycol, cellulose ether, sodium alginate, polyacrylic acid, polyacrylamide, and polymethacrylic acid.

Note that, as the resin, only one of the above resins may be used, or two or more of the above resins may be used in combination. The resin is contained in the heat-resistant layer at a proportion of preferably 25% by weight to 80% by weight and more preferably 30% by weight to 70% by weight when the total weight of the heat-resistant layer is 100% by weight.

### (Filler)

The heat-resistant layer may further contain a filler. The filler can be an inorganic filler or an organic filler. The filler is preferably an inorganic filler which is made of one or more inorganic oxides selected from the group consisting of silica, calcium oxide, magnesium oxide, magnesium hydroxide, titanium oxide, alumina, mica, zeolite, barium sulfate, aluminum hydroxide, boehmite, and the like. Note that in order to improve the water-absorbing property of the inorganic filler, an inorganic filler surface may be subjected to a hydrophilization treatment with, for example, a silane coupling agent.

The lower limit of a proportion at which the filler is contained in the heat-resistant layer may be not less than 0% by weight, may be more than 0% by weight, or may be not less than 10% by weight, when the total weight of the heat-resistant layer is regarded as 100% by weight. The filler is contained, in the heat-resistant layer, at a proportion of preferably not less than 20% by weight, more preferably not less than 30% by weight, and still more preferably not less than 50% by weight, from the viewpoint of an air permeability. The upper limit of the proportion at which the filler is contained in the heat-resistant layer is preferably not more than 80% by weight and more preferably not more than 70% by weight, when the total weight of the heat-resistant layer is regarded as 100% by weight.

The weight per unit area of the heat-resistant layer can be determined as appropriate in view of the strength, the thickness, the weight, and the handleability of the heat-resistant layer. The upper limit of the weight per unit area of the heat-resistant layer on one side of the laminated separator is preferably not more than 3.5 g/m², more preferably not more than 3.0 g/m², and still more preferably not more than 2.5 g/m². The lower limit of the weight per unit area of the heat-resistant layer on one side of the laminated separator is not particularly limited, but is preferably not less than 0.3 g/m², more preferably not less than 0.4 g/m², and still more preferably not less than 0.5 g/m². By setting the weight per unit area of the heat-resistant layer to fall within the above numerical range, it is possible to further increase the weight energy density and the volume energy density of the nonaqueous electrolyte secondary battery including the heat-resistant layer.

The weight per unit area of the heat-resistant layer can be measured by comparing the weight of the laminated separator which has the substrate and the heat-resistant layer with the weight of the laminated separator from which the heat-resistant layer is peeled off. The following is an example of such measurement.
1. The weight (W1) of the laminated separator which has the substrate and the heat-resistant layer is measured. Here, the areas of the laminated separator and the heat-resistant layer are each S1.
2. A peeling tape is attached to a surface of the laminated separator at which surface the heat-resistant layer is formed. By peeling off the peeling tape from the laminated separator, the heat-resistant layer is peeled off from the laminated separator to obtain the laminated separator from which the heat-resistant layer is peeled off. The obtained laminated separator may have a “portion which is constituted only by the substrate” and a “portion in which the substrate is permeated with the heat-resistant resin”.
3. The weight (W2) of the obtained laminated separator is measured.
4. The weight per unit area of the heat-resistant layer is calculated by a formula “(W1−W2)/S1”.

The heat-resistant layer has an air permeability of preferably 30 s/100 mL to 80 s/100 mL, and more preferably 40 s/100 mL to 75 s/100 mL, in terms of Gurley values. It can be said that the heat-resistant layer having an air permeability falling within the above range has sufficient ion permeability.

The heat-resistant layer has a porosity of preferably 20% by volume to 90% by volume, and more preferably 30% by volume to 80% by volume, so as to achieve sufficient ion permeability. The heat-resistant layer has pores whose diameter is preferably not more than 1.0 μm, and more preferably not more than 0.5 μm. By setting each of the pores to have such a diameter, it is possible to obtain the heat-resistant layer having sufficient ion permeability.

The lower limit of the thickness of the heat-resistant layer on one side of the laminated separator is preferably not less than 0.1 μm, more preferably not less than 0.3 μm, and still more preferably not less than 0.5 μm. The upper limit of the thickness of the heat-resistant layer on one side of the laminated separator is preferably not more than 20 μm, more preferably not more than 10 μm, and still more preferably not more than 5 μm. Examples of a combination of the lower limit and the upper limit of the thickness of the heat-resistant layer include 0.1 μm to 20 μm, 0.3 μm to 10 μm, and 0.5 μm to 5 μm. When the thickness of the heat-resistant layer falls within the above range, it is possible for the heat-resistant layer to sufficiently exert a function of the heat-resistant layer (e.g., to impart heat resistance) and also to make the total thickness of the laminated separator reduced.

### Examples of Preferable Combination of Resin and Filler

In an embodiment, the resin contained in the heat-resistant layer has an intrinsic viscosity of 1.4 dL/g to 4.0 dL/g, and the filler has an average particle diameter of not more than 1.0 μm. Use of the heat-resistant layer having such composition makes it possible to prepare the laminated separator which achieves all of heat resistance, ion permeability and reduction in thickness.

The lower limit of the intrinsic viscosity of the resin contained in the heat-resistant layer is preferably not less than 1.4 dL/g and more preferably not less than 1.5 dL/g. The upper limit of the intrinsic viscosity of the resin contained in the heat-resistant layer is preferably not more than 4.0 dL/g, more preferably not more than 3.0 dL/g, and still more preferably not more than 2.0 dL/g. The heat-resistant layer containing the resin having an intrinsic viscosity of not less than 1.4 dL/g can impart sufficient heat resistance to the laminated separator. The heat-resistant layer containing the resin having an intrinsic viscosity of not more than 4.0 dL/g has sufficient ion permeability.

The intrinsic viscosity can be measured, for example, by the following method. Flow time is measured for each of (i) a solution obtained by dissolving the resin in a concentrated sulfuric acid (96% to 98%) and (ii) concentrated sulfuric acid (96% to 98%) in which no resin is dissolved. The intrinsic viscosity is determined from the measured flow time by the following formula.

Intrinsic viscosity [dL/g]=ln(T/T₀)/C
T: Flow time of concentrated sulfuric acid solution of resin
T₀: Flow time of concentrated sulfuric acid
C: Concentration of resin in concentrated sulfuric acid solution of resin [g/dL]

The resin having an intrinsic viscosity of 1.4 dL/g to 4.0 dL/g can be synthesized by adjusting a molecular weight distribution of the resin, the molecular weight distribution being adjusted by appropriately setting synthesis conditions (e.g., the amount of a monomer(s) to be put in, synthesis temperature, and synthesis time). Alternatively, a commercially available resin having an intrinsic viscosity of 1.4 dL/g to 4.0 dL/g may be used. In an embodiment, the resin having an intrinsic viscosity of 1.4 dL/g to 4.0 dL/g is an aramid resin.

The upper limit of the average particle diameter of the filler in the heat-resistant layer is preferably not more than 1.0 μm, and more preferably not more than 0.8 μm, from the viewpoint of reduction in thickness of the laminated separator. The lower limit of the average particle diameter of the filler in the heat-resistant layer is preferably not less than 0.005 μm, and more preferably not less than 0.010 μm, from the viewpoint of formation of a pore structure in the laminated separator.

The average particle diameter of the filler here is the average value of sphere equivalent particle diameters of 50 filler particles. A sphere equivalent particle diameter of a filler particle is a value which is obtained by actual measurement with use of a transmission electron microscope. The following is a specific example of a measurement method.
1. An image of the filler is captured with use of a transmission electron microscope (TEM; JEOL Ltd., transmission electron microscope JEM-2100F) at an acceleration voltage of 200 kV and a magnification ratio of 10,000 times with a Gatan Imaging Filter.
2. In the image thus obtained, an outline of a filler particle (primary particle) is traced with use of image analysis software (ImageJ), and the sphere equivalent particle diameter of the filler particle is measured.
3. The above measurement is carried out for 50 filler particles which have been randomly extracted. The arithmetic average of the sphere equivalent particle diameters of the 50 filler particles is regarded as the average particle diameter of the filler.

### <1.4. Particle Layer>

The laminated separator includes a particle layer which is provided on the at least one side of the laminated separator. That is, as described in the above section <1.1. Configurations of laminated separator>, the particle layer may be provided at the surface of the laminated separator or another layer may be further provided on the particle layer. Further, the particle layer may be provided on a surface of the polyolefin-based substrate or on a surface of the heat-resistant layer.

For example, when the laminated separator has the heat-resistant layer on one surface of the polyolefin-based substrate, the particle layer may be provided on the surface of the heat-resistant layer as illustrated in FIG. 3, or the particle layer may be provided on the surface which is of the polyolefin-based substrate and which does not have the heat-resistant layer as illustrated in FIG. 4. Alternatively, as illustrated in FIG. 5, the particle layer may be provided on both of the surface of the polyolefin-based substrate and the surface of the heat-resistant layer.

The lower limit of the weight per unit area of the particle layer on one side of the laminated separator is preferably not less than 0.01 g/m², more preferably not less than 0.05 g/m², and still more preferably not less than 0.08 g/m². The upper limit of the weight per unit area of the particle layer on one side of the laminated separator is preferably not more than 1.0 g/m², more preferably not more than 0.95 g/m², and still more preferably not more than 0.9 g/m². By setting the weight per unit area of the particle layer to fall within the above range, it is possible to obtain the laminated separator having excellent ion permeability. The upper limit of the weight per unit area of the particle layer on one side of the laminated separator may be less than 0.2 g/m², or may be not more than 0.15 g/m².

The weight per unit area of the particle layer is measured by comparing the weight of the laminated separator which has the particle layer with the weight of the laminated separator from which the particle layer is removed. The following is an example of such measurement.
1. The weight (W3) of the laminated separator which has the particle layer is measured. Further, the area (S2) of the particle layer is measured.
2. The particle layer is removed from the laminated separator by cleaning with an appropriate solvent. Thereafter, the solvent is removed, for example, by drying.
3. The weight (W4) of the laminated separator from which the particle layer has been removed is measured.
4. The weight per unit area of the particle layer is calculated by a formula “(W3−W4)/S2”.

The particle layer has an air permeability of preferably 0 s/100 mL to 150 s/100 mL, and more preferably 5 s/100 mL to 100 s/100 mL, in terms of Gurley values. It can be said that the particle layer having an air permeability falling within the above range has sufficient ion permeability.

The particle layer has a porosity of preferably 1% by volume to 60% by volume, and more preferably 2% by volume to 30% by volume, so as to (i) retain a larger amount of the electrolyte and (ii) obtain the function of reliably preventing a flow of an excessively large electric current at a lower temperature.

The lower limit of the thickness of the particle layer on one side of the laminated separator is preferably not less than 0.1 μm, more preferably not less than 0.3 μm, and still more preferably not less than 0.5 μm. The upper limit of the thickness of the particle layer on one side of the laminated separator is preferably not more than 10 μm, more preferably not more than 8 μm, and still more preferably not more than 7 μm.

The lower limit of the average particle diameter of particles contained in the particle layer is preferably not less than 0.1 μm, more preferably not less than 0.3 μm, and still more preferably not less than 0.5 μm. The upper limit of the average particle diameter of the particles contained in the particle layer is preferably not more than 10 μm, more preferably not more than 8 μm, and still more preferably not more than 7 μm.

The average particle diameter of the particles is a value which is obtained by actual measurement with use of a scanning electron microscope. The following is a specific example of a measurement method.
1. A scanning electron microscope (SEM) image of a surface of the particle layer is captured with use of an SEM.
2. On the SEM image thus obtained, three or more fields of view are observed with use of image analysis software, respective outlines of not less than 100 particles are traced, and the particle diameter of each of the particles is measured.
3. The arithmetic average of the particles thus measured is regarded as the average particle diameter.

A resin which constitutes the particles may include a thermoplastic resin. Examples of a monomer that becomes a constituent unit of the resin which constitutes the particles include: vinyl chloride-based monomers such as vinyl chloride and vinylidene chloride; vinyl acetate-based monomers such as vinyl acetate; aromatic vinyl monomers such as styrene, α-methyl styrene, styrene sulfonic acid, butoxystyrene, and vinyl naphthalene; vinyl amine-based monomers such as vinyl amine; vinyl amide-based monomers such as N-vinyl formamide and N-vinyl acetamide; acid group-containing monomers such as monomers each having a carboxylic acid group, monomers each having a sulfonic acid group, monomers each having a phosphoric acid group, and monomers each having a hydroxyl group; (meth)acrylic acid derivatives such as 2-hydroxyethyl methacrylate; (meth)acrylic ester monomers such as methyl acrylate, ethyl acrylate, methyl methacrylate, ethyl methacrylate, and 2-ethylhexyl acrylate; (meth)acrylamide monomers such as acrylamide and methacrylamide; (meth)acrylonitrile monomers such as acrylonitrile and methacrylonitrile; fluorine-containing (meth)acrylate monomers such as 2-(perfluorohexyl)ethyl methacrylate and 2-(perfluorobutyl)ethyl acrylate; maleimides; maleimide derivatives such as phenylmaleimide; diene-based monomers such as 1,3-butadiene and isoprene; and vinylidene fluoride monomers. One of these monomers may be used alone, or two or more of these monomers may be used in combination at any ratio. Note that, in the present specification, the “(meth)acrylic” means “acrylic” and/or “methacrylic”.

Among the above monomers, (meth)acrylic ester monomers and/or vinylidene fluoride monomers are preferable. That is, the particles preferably contain an acrylic resin that contains a (meth)acrylic ester monomer as a constituent unit and/or a polyvinylidene fluoride resin that contains a vinylidene fluoride monomer as a constituent unit.

The lower limit of the proportion of a (meth)acrylic ester monomer unit contained in the acrylic resin is preferably not less than 50% by weight, more preferably not less than 55% by weight, still more preferably not less than 60% by weight, and particularly preferably not less than 70% by weight. The upper limit of the proportion of the (meth)acrylic ester monomer unit contained in the acrylic resin is preferably not more than 100% by weight, more preferably not more than 99% by weight, and still more preferably not more than 95% by weight.

Examples of the (meth)acrylic ester monomers that can form the (meth)acrylic ester monomer unit include: acrylic acid alkyl esters such as methyl acrylate, ethyl acrylate, n-propyl acrylate, isopropyl acrylate, butyl acrylate (e.g., n-butyl acrylate and t-butyl acrylate), pentyl acrylate, hexyl acrylate, heptyl acrylate, octyl acrylate (e.g., 2-ethylhexyl acrylate), nonyl acrylate, decyl acrylate, lauryl acrylate, n-tetradecyl acrylate, and stearyl acrylate; and methacrylic acid alkyl esters such as methyl methacrylate, ethyl methacrylate, n-propyl methacrylate, isopropyl methacrylate, butyl methacrylate (e.g., n-butyl methacrylate and t-butyl methacrylate), pentyl methacrylate, hexyl methacrylate, heptyl methacrylate, octyl methacrylate (e.g., 2-ethylhexyl methacrylate), nonyl methacrylate, decyl methacrylate, lauryl methacrylate, n-tetradecyl methacrylate, and stearyl methacrylate. Among these monomers, butyl acrylate and methyl methacrylate are preferable, and butyl acrylate is more preferable. One of the (meth)acrylic ester monomers may be used alone, or two or more of the (meth)acrylic ester monomers may be used in combination at any ratio.

The acrylic resin may have a unit other than the (meth)acrylic ester monomer unit. For example, the acrylic resin may contain an acid group-containing monomer unit. Examples of the acid group-containing monomer include monomers each having an acid group, for example, a monomer having a carboxylic acid group, a monomer having a sulfonic acid group, a monomer having a phosphoric acid group, and a monomer having a hydroxyl group.

Examples of the monomer having a carboxylic acid group include a monocarboxylic acid and a dicarboxylic acid. Examples of the monocarboxylic acid include acrylic acid, methacrylic acid, and crotonic acid. Examples of the dicarboxylic acid include maleic acid, fumaric acid, and itaconic acid.

Examples of the monomer having a sulfonic acid group include vinyl sulfonic acid, methylvinyl sulfonic acid, (meth)allyl sulfonic acid, (meth)acrylic acid 2-ethyl sulfonate, 2-acrylamido-2-methylpropane sulfonic acid, and 3-allyloxy-2-hydroxypropane sulfonic acid.

Examples of the monomer having a phosphoric acid group include 2-(meth)acryloyloxyethyl phosphate, methyl-2-(meth)acryloyloxyethyl phosphate, and ethyl-(meth)acryloyloxyethyl phosphate.

Examples of the monomer having a hydroxyl group include 2-hydroxyethyl acrylate, 2-hydroxypropyl acrylate, 2-hydroxyethyl methacrylate, and 2-hydroxypropyl methacrylate.

Among these monomers, the acid group-containing monomer is preferably a monomer having a carboxylic acid group. Among monomers each having a carboxylic acid group, the monomer having a carboxylic acid group is preferably a monocarboxylic acid and more preferably a (meth)acrylic acid. One of these acid group-containing monomers may be used alone, or two or more of these acid group-containing monomers may be used in combination at any ratio.

The lower limit of the proportion of the acid group-containing monomer unit in the acrylic resin is preferably not less than 0.1% by weight, more preferably not less than 1% by weight, and still more preferably not less than 3% by weight. The upper limit of the proportion of the acid group-containing monomer unit in the acrylic resin is preferably not more than 20% by weight, more preferably not more than 10% by weight, and still more preferably not more than 7% by weight.

The acrylic resin preferably contains a cross-linkable monomer unit in addition to the above monomer unit. A cross-linkable monomer is a monomer which, upon heating or irradiation with an energy beam, can form a cross-linked structure during or after polymerization. Inclusion of the cross-linkable monomer unit makes it possible to easily keep a degree of swelling of the polymer in a specific range.

Examples of the cross-linkable monomer include a multifunctional monomer which has two or more polymerization reactive groups in the monomer. Examples of such a multifunctional monomer include: divinyl compounds such as divinylbenzene; di(meth)acrylic ester compounds such as diethylene glycol dimethacrylate, ethylene glycol dimethacrylate, diethylene glycol diacrylate, and 1,3-butylene glycol diacrylate; tri(meth)acrylic ester compounds such as trimethylolpropane trimethacrylate and trimethylolpropane triacrylate; and ethylenically unsaturated monomers each containing an epoxy group such as allyl glycidyl ether and glycidyl methacrylate. Among these monomers, the dimethacrylic ester compounds and the ethylenically unsaturated monomers each containing an epoxy group are preferable, and the dimethacrylic ester compounds are more preferable. One of these monomers may be used alone, or two or more of these monomers may be used in combination at any ratio.

The lower limit of the proportion of the cross-linkable monomer unit in the acrylic resin is preferably not less than 0.1% by weight, more preferably not less than 0.2% by weight, and still more preferably not less than 0.5% by weight. The upper limit of the proportion of the cross-linkable monomer unit in the acrylic resin is preferably not more than 5% by weight, more preferably not more than 4% by weight, and still more preferably not more than 3% by weight.

Examples of the polyvinylidene fluoride resin include polyvinylidene fluoride and copolymers of vinylidene fluoride and the other monomers. Examples of the other monomers copolymerizable with vinylidene fluoride include tetrafluoroethylene, hexafluoropropylene, trifluoroethylene, chlorotrifluoroethylene, trichloroethylene, vinyl fluoride, trifluoroperfluoropropyl ether, ethylene, (meth)acrylic acid, methyl (meth)acrylate, (meth)acrylic ester, vinyl acetate, vinyl chloride, and acrylonitrile.

Examples of a structure of the particles include a structure in which individual polymers having a particle shape exist separately, a structure in which individual polymers having a particle shape exist in contact with each other, and a structure in which individual polymers having a particle shape exist in a complexed form.

When the individual particles exist in contact with each other or in a complexed form, the particles may have, for example, a core-shell structure. The core-shell structure may have a shell that covers the entire outer surface of a core or a shell that partially covers the outer surface of the core. In view of ion permeability, the shell preferably partially covers the core. In the particles that have the core-shell structure in which the shell partially covers the core, it is preferable that there be two types of particles, that is, a core particle and shell particles, and that the shell particles cover the outer surface of the core particle. When the particles have the core-shell structure, the average particle diameter of the particles refers to the average of respective particle diameters of whole particles which have the core-shell structure.

Generally, thermocompression bonding of the electrode to the laminated separator is carried out at a temperature of not higher than 100° C. Therefore, the glass transition temperature of the particles is preferably not lower than 0° C. and not higher than 80° C. In view of prevention of adhesion of separators, the glass transition temperature is more preferably not lower than 20° C. and not higher than 80° C.

The particle layer may contain another component different from the particles, provided that the object of the present invention is not prevented from being attained. Examples of the another component include fillers. In a case where the particle layer further contains a filler, voids are maintained at an appropriate volume by the filler and, accordingly, the ion permeability is unlikely to be impaired, even when the particles are crushed by adhesion with an electrode or expansion of the electrode due to charge and discharge. The filler preferably has an average particle diameter equivalent to or smaller than the average particle diameter of the particles. As the filler, any of the materials listed as examples in the section <1.3. Heat-resistant layer> can be used.

### <1.5. Physical Properties of Laminated Separator>

### (Air Permeability)

The laminated separator has an air permeability of preferably not more than 500 s/100 mL, more preferably not more than 400 s/100 mL, and still more preferably not more than 300 s/100 mL, in terms of Gurley values. It can be said that the laminated separator having an air permeability falling within the above range has sufficient ion permeability.

### (Porosity)

The laminated separator has a porosity of preferably 20% by volume to 80% by volume, more preferably 30% by volume to 70% by volume, and still more preferably 40% by volume to 60% by volume, so as to (i) retain a larger amount of the electrolyte and (ii) obtain the function of reliably preventing a flow of an excessively large electric current at a lower temperature.

### Embodiment 2

A laminated separator for a nonaqueous electrolyte secondary battery in accordance with Embodiment 2 is a laminated separator which is for a nonaqueous electrolyte secondary battery and which includes a polyolefin-based substrate and a heat-resistant layer that is provided on one surface or both surfaces of the polyolefin-based substrate, the laminated separator including a particle layer which is provided on at least one side of the laminated separator, a standard deviation of surface roughness on a surface of the laminated separator which surface is located on the at least one side on which the particle layer is provided being not more than 0.06.

The inventors of the present invention found it possible to provide a laminated separator which makes it possible to obtain a battery having an excellent rate characteristic and which has excellent heat resistance, by controlling not mere surface roughness but the standard deviation of the surface roughness on a surface of the laminated separator which surface is located on a side on which a particle layer is provided. It is considered that, in a laminated separator in which the standard deviation of surface roughness is controlled as described above, a distribution of particles in an in-plane direction and a distribution of particles in a thickness direction are uniformly controlled. Therefore, it is considered possible to achieve the same effect as that of the laminated separator in accordance with Embodiment 1.

In the present specification, the surface roughness means an arithmetic average height (Sa) which is defined in ISO 25178. The standard deviation of the surface roughness is preferably not more than 0.06, and more preferably not more than 0.05. The smaller the standard deviation of the surface roughness is, the more preferable it is. The lower limit of the standard deviation of the surface roughness may be, for example, not less than 0.01. The lower limit of the average value of the surface roughness is preferably not less than 0.05, and more preferably not less than 0.10. The upper limit of the average value of the surface roughness may be not more than 0.6, or may be not more than 0.5.

The configuration and the physical properties of the laminated separator can be described with reference to the matters described in [Embodiment 1], and, therefore, description thereof is omitted.

### Embodiment 3

A laminated separator for a nonaqueous electrolyte secondary battery in accordance with Embodiment 3 is a laminated separator which is for a nonaqueous electrolyte secondary battery and which includes a polyolefin-based substrate and a heat-resistant layer that is provided on one surface or both surfaces of the polyolefin-based substrate, the laminated separator including a particle layer which is provided on at least one side of the laminated separator, a standard deviation of an IR peak intensity ratio on a surface of the laminated separator which surface is located on the at least one side on which the particle layer is provided being not more than 0.025, the IR peak intensity ratio being calculated from the following formula.

IR peak intensity ratio=peak intensity which is of a resin contained in the particle layer and which is in an infrared absorption spectrum/peak intensity which is of a resin contained in the heat-resistant layer and which is in an infrared absorption spectrum

The inventors of the present invention found it possible to provide a laminated separator which makes it possible to obtain a battery having an excellent rate characteristic and which has excellent heat resistance, by controlling not a mere IR peak intensity ratio but the standard deviation of the IR peak intensity ratio on a surface of the laminated separator which surface is located on a side on which a particle layer is provided. It is considered that, in a laminated separator in which the standard deviation of an IR peak intensity ratio is controlled as described above, a distribution of particles in an in-plane direction and a distribution of particles in a thickness direction are uniformly controlled. Therefore, it is considered possible to achieve the same effect as that of the laminated separator in accordance with Embodiment 1.

In the present specification, the peak intensity of the resin contained in the heat-resistant layer means the peak intensity of a peak which indicates the resin contained in the heat-resistant layer. It can be said that the peak is a peak indicating a heat-resistant resin. The peak can be a peak which is associated with an amide bond in the heat-resistant resin, for example, an aramid resin. The peak is a peak that is present, for example, in the wave number range of 1,620 cm⁻¹ to 1,700 cm⁻¹.

In the present specification, the peak intensity of the resin contained in the particle layer means the peak intensity of a peak which indicates the resin contained in the particle layer. It can be said that the peak is a peak indicating the resin which constitutes particles contained in the particle layer. The peak can be a peak which is associated with an ester bond in the resin which constitutes the particles, for example, an acrylic resin. The peak is a peak that is present, for example, in the wave number range of 1,700 cm⁻¹ to 1,900 cm⁻¹. Alternatively, the peak can be a peak which is associated with, for example, a C—F bond in a polyvinylidene fluoride resin. The peak is a peak that is present, for example, in the wave number range of 1,000 cm⁻¹ to 1,100 cm⁻¹.

Note that, in a case where the types of resins contained in a particle layer and a heat-resistant layer of an acquired separator are unclear, peaks may be determined by comparing infrared absorption spectra (IR spectra) of the separator before and after the particle layer is removed. First, obtained is an IR spectrum of a sample of the separator before a surface of the separator is cleaned, that is, a sample before the particle layer is removed. Further obtained is an IR spectrum of the sample after the surface of the separator is immersed in a solvent (such as water, acetone, or N-methyl-2-pyrrolidone) and cleaned with use of an ultrasonic wave, that is, the sample after the particle layer is removed. The obtained IR spectra of the sample before and after the cleaning are compared, and the intensity of a peak which has disappeared after the cleaning may be defined as the peak intensity of the resin contained in the particle layer, and the intensity of a peak which has not disappeared after the cleaning may be defined as the peak intensity of the resin contained in the heat-resistant layer.

The standard deviation of the IR peak intensity ratio is preferably not more than 0.025, and more preferably not more than 0.020. The smaller the standard deviation of the IR peak intensity ratio is, the more preferable it is. The lower limit of the standard deviation of the IR peak intensity ratio may be, for example, not less than 0.001. The lower limit of the average value of the IR peak intensity ratio is preferably not less than 0.05, and more preferably not less than 0.10. The upper limit of the average value of the IR peak intensity ratio may be not more than 1.0, or may be not more than 0.9.

The configuration and the physical properties of the laminated separator can be described with reference to the matters described in [Embodiment 1], and, therefore, description thereof is omitted.

### Embodiment 4

A laminated separator for a nonaqueous electrolyte secondary battery in accordance with Embodiment 4 is a laminated separator which is for a nonaqueous electrolyte secondary battery and which includes a polyolefin-based substrate and a heat-resistant layer that is provided on one surface or both surfaces of the polyolefin-based substrate, the laminated separator including a particle layer which is provided on at least one side of the laminated separator, a product of a standard deviation of a 60-degree specular gloss and a standard deviation of surface roughness on a surface of the laminated separator which surface is located on the at least one side on which the particle layer is provided being not more than 0.06.

The inventors of the present invention found it possible to provide a laminated separator which makes it possible to obtain a battery having an excellent rate characteristic and which has excellent heat resistance, by controlling not a mere 60-degree gloss and/or mere surface roughness but the product of the standard deviation of the 60-degree gloss and the standard deviation of the surface roughness on a surface of the laminated separator which surface is located on a side on which a particle layer is provided. It is considered that, in a laminated separator in which the product of the standard deviation of a 60-degree gloss and the standard deviation of surface roughness is controlled as described above, the standard deviation of the 60-degree gloss and the standard deviation of the surface roughness are small and, therefore, a distribution of particles in an in-plane direction and a distribution of particles in a thickness direction are uniformly controlled. Therefore, it is considered possible to achieve the same effect as that of the laminated separator in accordance with Embodiment 1.

The product of the standard deviation of the 60-degree gloss and the standard deviation of the surface roughness is preferably not more than 0.06, and more preferably not more than 0.05. The smaller the product of the standard deviation of the 60-degree gloss and the standard deviation of the surface roughness is, the more preferable it is. The lower limit of the product may be, for example, not less than 0.001.

The configuration and the physical properties of the laminated separator can be described with reference to the matters described in [Embodiment 1], and, therefore, description thereof is omitted.

### Embodiment 5

A laminated separator for a nonaqueous electrolyte secondary battery in accordance with Embodiment 5 is a laminated separator which is for a nonaqueous electrolyte secondary battery and which includes a polyolefin-based substrate and a heat-resistant layer that is provided on one surface or both surfaces of the polyolefin-based substrate, the laminated separator including a particle layer which is provided on at least one side of the laminated separator, a product of a standard deviation of a 60-degree specular gloss and a standard deviation of an IR peak intensity ratio on a surface of the laminated separator which surface is located on the at least one side on which the particle layer is provided being not more than 0.016, the IR peak intensity ratio being calculated from the following formula.

IR peak intensity ratio=peak intensity which is of a resin contained in the particle layer and which is in an infrared absorption spectrum/peak intensity which is of a resin contained in the heat-resistant layer and which is in an infrared absorption spectrum

The inventors of the present invention found it possible to provide a laminated separator which makes it possible to obtain a battery having an excellent rate characteristic and which has excellent heat resistance, by controlling not a mere 60-degree gloss and/or a mere IR peak intensity ratio but the product of the standard deviation of the 60-degree gloss and the standard deviation of the IR peak intensity ratio on a surface of the laminated separator which surface is located on a side on which a particle layer is provided. It is considered that, in a laminated separator in which the product of the standard deviation of a 60-degree gloss and the standard deviation of an IR peak intensity ratio is controlled as described above, the standard deviation of the 60-degree gloss and the standard deviation of the IR peak intensity ratio are small and, therefore, a distribution of particles in an in-plane direction and a distribution of particles in a thickness direction are uniformly controlled. Therefore, it is considered possible to achieve the same effect as that of the laminated separator in accordance with Embodiment 1.

The product of the standard deviation of the 60-degree gloss and the standard deviation of the IR peak intensity ratio is preferably not more than 0.016, and more preferably not more than 0.012. The smaller the product of the standard deviation of the 60-degree gloss and the standard deviation of the IR peak intensity ratio is, the more preferable it is. The lower limit of the product may be, for example, not less than 0.0001.

The configuration and the physical properties of the laminated separator can be described with reference to the matters described in [Embodiment 1], and, therefore, description thereof is omitted.

### Embodiment 6

A laminated separator for a nonaqueous electrolyte secondary battery in accordance with Embodiment 6 is a laminated separator which is for a nonaqueous electrolyte secondary battery and which includes a polyolefin-based substrate and a heat-resistant layer that is provided on one surface or both surfaces of the polyolefin-based substrate, the laminated separator including a particle layer which is provided on at least one side of the laminated separator, a product of a standard deviation of surface roughness and a standard deviation of an IR peak intensity ratio on a surface of the laminated separator which surface is located on the at least one side on which the particle layer is provided being not more than 0.0016, the IR peak intensity ratio being calculated from the following formula.

IR peak intensity ratio=peak intensity which is of a resin contained in the particle layer and which is in an infrared absorption spectrum/peak intensity which is of a resin contained in the heat-resistant layer and which is in an infrared absorption spectrum

The inventors of the present invention found it possible to provide a laminated separator which makes it possible to obtain a battery having an excellent rate characteristic and which has excellent heat resistance, by controlling not mere surface roughness and/or a mere IR peak intensity ratio but the product of the standard deviation of the surface roughness and the standard deviation of the IR peak intensity ratio on a surface of the laminated separator which surface is located on a side on which a particle layer is provided. It is considered that, in a laminated separator in which the product of the standard deviation of surface roughness and the standard deviation of an IR peak intensity ratio is controlled as described above, the standard deviation of the surface roughness and the standard deviation of the IR peak intensity ratio are small and, therefore, a distribution of particles in an in-plane direction and a distribution of particles in a thickness direction are uniformly controlled. Therefore, it is considered possible to achieve the same effect as that of the laminated separator in accordance with Embodiment 1.

The product of the standard deviation of the surface roughness and the standard deviation of the IR peak intensity ratio is preferably not more than 0.0016, and more preferably not more than 0.0012. The smaller the product of the standard deviation of the surface roughness and the standard deviation of the IR peak intensity ratio is, the more preferable it is. The lower limit of the product may be, for example, not less than 0.00001.

The configuration and the physical properties of the laminated separator can be described with reference to the matters described in [Embodiment 1], and, therefore, description thereof is omitted.

### Embodiment 7

A laminated separator for a nonaqueous electrolyte secondary battery in accordance with Embodiment 7 is a laminated separator which is for a nonaqueous electrolyte secondary battery and which includes a polyolefin-based substrate and a heat-resistant layer that is provided on one surface or both surfaces of the polyolefin-based substrate, the laminated separator including a particle layer which is provided on at least one side of the laminated separator, a product of a standard deviation of a 60-degree specular gloss, a standard deviation of surface roughness, and a standard deviation of an IR peak intensity ratio on a surface of the laminated separator which surface is located on the at least one side on which the particle layer is provided being not more than 0.0015, the IR peak intensity ratio being calculated from the following formula.

IR peak intensity ratio=peak intensity which is of a resin contained in the particle layer and which is in an infrared absorption spectrum/peak intensity which is of a resin contained in the heat-resistant layer and which is in an infrared absorption spectrum

The inventors of the present invention found it possible to provide a laminated separator which makes it possible to obtain a battery having an excellent rate characteristic and which has excellent heat resistance, by controlling not a mere 60-degree gloss, mere surface roughness, and/or a mere IR peak intensity ratio but the product of the standard deviation of the 60-degree gloss, the standard deviation of the surface roughness, and the standard deviation of the IR peak intensity ratio on a surface of the laminated separator which surface is located on a side on which a particle layer is provided. It is considered that, in a laminated separator in which the product of the standard deviation of a 60-degree gloss, the standard deviation of surface roughness, and the standard deviation of an IR peak intensity ratio is controlled as described above, the standard deviation of the 60-degree gloss, the standard deviation of the surface roughness, and the standard deviation of the IR peak intensity ratio are small and, therefore, a distribution of particles in an in-plane direction and a distribution of particles in a thickness direction are uniformly controlled. Therefore, it is considered possible to achieve the same effect as that of the laminated separator in accordance with Embodiment 1.

The product of the standard deviation of the 60-degree gloss, the standard deviation of the surface roughness, and the standard deviation of the IR peak intensity ratio is preferably not more than 0.0015, and more preferably not more than 0.0010. The smaller the product of the standard deviation of the 60-degree gloss, the standard deviation of the surface roughness, and the standard deviation of the IR peak intensity ratio is, the more preferable it is. The lower limit of the product may be, for example, not less than 0.000001.

The configuration and the physical properties of the laminated separator can be described with reference to the matters described in [Embodiment 1], and, therefore, description thereof is omitted.

### [2. Method for Producing Laminated Separator for Nonaqueous Electrolyte Secondary Battery]

### <2.1. Method for Producing Polyolefin-Based Substrate>

The following method is an example of a method for producing the polyolefin-based substrate. That is, first, a polyolefin-based resin is kneaded together with a pore forming agent such as an inorganic bulking agent or a plasticizer, and optionally with another agent(s) such as an antioxidant, so as to produce a polyolefin-based resin composition. Then, the polyolefin-based resin composition is extruded, so that a polyolefin-based resin composition in a sheet form is prepared. Further, the pore forming agent is removed from the polyolefin-based resin composition in the sheet form with use of an appropriate solvent. Thereafter, the polyolefin-based substrate can be produced by stretching the polyolefin-based resin composition from which the pore forming agent has been removed.

The inorganic bulking agent is not particularly limited. Examples of the inorganic bulking agent include inorganic fillers; one specific example is calcium carbonate. The plasticizer is not particularly limited. The plasticizer can be a low molecular weight hydrocarbon such as liquid paraffin.

### <2.2. Method for Producing Heat-Resistant Layer>

The heat-resistant layer can be formed with use of a coating solution in which the resin described in the section <1.3. Heat-resistant layer> is dissolved or dispersed in a solvent. Further, the heat-resistant layer containing the resin and the filler can be formed with use of a coating solution which is obtained by (i) dissolving or dispersing the resin in a solvent and (ii) dispersing the filler in the solvent. The coating solution may contain, as appropriate, a disperser, a plasticizer, a surfactant, a pH adjustor, and/or the like, as a component(s) other than the resin and the filler.

Note that the solvent can be a solvent in which the resin is to be dissolved. Further, the solvent can be a dispersion medium in which the resin or the filler is to be dispersed. Examples of a method for forming the coating solution include a mechanical stirring method, an ultrasonic dispersion method, a high-pressure dispersion method, and a media dispersion method.

Examples of the method for forming the heat-resistant layer include: a method in which the coating solution is applied directly to a surface of a substrate and then the solvent is removed; a method in which (i) the coating solution is applied to an appropriate support, (ii) the solvent is removed so that the heat-resistant layer is formed, (iii) the heat-resistant layer and the substrate are bonded together by pressure, and then (iv) the support is peeled off; a method in which (i) the coating solution is applied to an appropriate support, (ii) the substrate is bonded to a resultant coated surface by pressure, (iii) the support is peeled off, and then (iv) the solvent is removed; and a method in which dip coating is carried out by immersing the substrate in the coating solution, and then the solvent is removed.

It is preferable that the solvent be a solvent which (i) does not adversely affect the substrate, (ii) allows the resin to be dissolved uniformly and stably, and (iii) allows the filler to be dispersed uniformly and stably. The solvent can be one or more solvents selected from the group consisting of, for example, N-methyl-2-pyrrolidone, N, N-dimethylacetamide, N,N-dimethylformamide, acetone, and water.

The coating solution can be applied to the substrate by a conventionally known method. Specific examples of such a method include a gravure coater method, a dip coater method, a bar coater method, and a die coater method. The solvent can be removed from a film of the coating solution with which the substrate has been coated, for example, by air blow drying or heat drying. In a case where the coating solution contains an aramid resin, the aramid resin can be deposited by applying humidity to the coated surface. The heat-resistant layer may be formed in this way.

Further, the porosity and the average pore diameter of the heat-resistant layer to be obtained can be adjusted by changing the amount of the solvent in the coating solution. A suitable solid content concentration of the coating solution can vary depending on, for example, the type of the filler, but generally, the solid content concentration is preferably higher than 3% by weight and not higher than 40% by weight.

When the substrate is coated with the coating solution, a coating shear rate can vary depending on, for example, the type of the filler. Generally, the coating shear rate is preferably not lower than 2 (1/s) and more preferably 4 (1/s) to 50 (1/s).

### (Method for Preparing Aramid Resin)

Examples of a method for preparing the aramid resin include, but are not particularly limited to, condensation polymerization of para-oriented aromatic diamine and para-oriented aromatic dicarboxylic acid halide. In such a method, the aramid resin obtained is substantially composed of repeating units in which amide bonds occur at para or quasi-para position in an aromatic ring. The “quasi-para positions” refers to positions at which bonds extend in opposing directions from each other, coaxially or in parallel, such as 4 and 4′ positions of biphenylene, 1 and 5 positions of naphthalene, and 2 and 6 positions of naphthalene.

### <2.3. Method for Producing Particle Layer>

The particle layer can be formed by applying, to the substrate or to the heat-resistant layer, a slurry that contains the above-described particles, and then drying the slurry. The slurry may contain another component in addition to the above-described particles. Examples of such another component include a binder, a disperser, and a wetting agent.

In forming the particle layer, a method for applying and drying the slurry is not particularly limited. Examples of the method for applying the slurry include a gravure coater method, a dip coater method, a bar coater method, and a die coater method. Here, by (i) supplying the slurry to a coater portion while stirring the slurry in a container containing the slurry and (ii) applying the slurry to the substrate or the heat-resistant layer, it is possible to suitably obtain the particle layer in which the standard deviation(s) of the gloss, the surface roughness, and/or the IR peak intensity ratio is/are controlled so as to be small as in the above embodiments.

Meanwhile, examples of the method for drying the slurry include drying by warm air, hot air or low humidity air, vacuum drying, and drying by irradiation with (far) infrared rays or electron rays. The temperature at which the slurry applied is dried can be varied depending on the type of the solvent used.

### [3. Material for Nonaqueous Electrolyte Secondary Battery and Nonaqueous Electrolyte Secondary Battery]

A material for a nonaqueous electrolyte secondary battery in accordance with an embodiment of the present invention includes a positive electrode, the above-described laminated separator, and a negative electrode which are formed in this order. A nonaqueous electrolyte secondary battery in accordance with an embodiment of the present invention includes the above-described laminated separator.

The nonaqueous electrolyte secondary battery is not particularly limited in shape and can have any shape such as the shape of a thin plate (sheet), a disk, a cylinder, or a prism such as a cuboid. The nonaqueous electrolyte secondary battery is, for example, a nonaqueous electrolyte secondary battery that achieves an electromotive force through doping with and dedoping of lithium. The nonaqueous electrolyte secondary battery includes the material that is for a nonaqueous electrolyte secondary battery and that includes a positive electrode, the above-described laminated separator, and a negative electrode which are formed in this order. Note that components, other than the above-described laminated separator, of the nonaqueous electrolyte secondary battery are not limited to those described below.

The nonaqueous electrolyte secondary battery is generally structured such that a battery element is enclosed in an exterior member, the battery element including (i) a structure in which the negative electrode and the positive electrode face each other with the above-described laminated separator therebetween and (ii) an electrolyte with which the structure is impregnated. Note that the doping means occlusion, support, adsorption, or insertion, and means a phenomenon in which lithium ions enter an active material of an electrode (e.g., a positive electrode).

### <3.1. Positive Electrode>

The positive electrode is not limited to any particular one, provided that the positive electrode is one that is generally used as a positive electrode of a nonaqueous electrolyte secondary battery. Examples of the positive electrode include a positive electrode sheet having a structure in which an active material layer, containing a positive electrode active material and a binding agent, is formed on a positive electrode current collector. Note that the active material layer may further contain an electrically conductive agent and/or a binding agent.

Examples of the positive electrode active material include materials each capable of being doped with and dedoped of lithium ions. Specific examples of the materials include lithium complex oxides each containing at least one transition metal such as V, Mn, Fe, Co, or Ni.

Examples of the electrically conductive agent include carbonaceous materials such as natural graphite, artificial graphite, cokes, carbon black, pyrolytic carbons, carbon fiber, and fired products of organic polymer compounds. Only one of the above electrically conductive agents may be used, or two or more of the above electrically conductive agents may be used in combination.

Examples of the binding agent include: fluorine-based resins such as polyvinylidene fluoride (PVDF); acrylic resin; and styrene butadiene rubber. Note that the binding agent serves also as a thickener.

Examples of the positive electrode current collector include electric conductors such as Al, Ni, and stainless steel. Among these electric conductors, Al is more preferable because Al is easily processed into a thin film and is inexpensive.

Examples of a method for producing the positive electrode sheet includes: a method in which the positive electrode active material, the electrically conductive agent, and the binding agent are pressure-molded on the positive electrode current collector; and a method in which (i) the positive electrode active material, the electrically conductive agent, and the binding agent are formed into a paste with use of an appropriate organic solvent, (ii) the positive electrode current collector is coated with the paste, and (iii) the paste is dried and then pressurized so that the paste is firmly fixed to the positive electrode current collector.

### <3.2. Negative Electrode>

The negative electrode is not limited to any particular one, provided that the negative electrode is one that is generally used as a negative electrode of a nonaqueous electrolyte secondary battery. Examples of the negative electrode include a negative electrode sheet having a structure in which an active material layer, containing a negative electrode active material and a binding agent, is formed on a negative electrode current collector. Note that the active material layer may further contain an electrically conductive agent and/or a binding agent.

Examples of the negative electrode active material include materials each capable of being doped with and dedoped of lithium ions. Examples of the materials include carbonaceous materials. Examples of the carbonaceous materials include natural graphite, artificial graphite, cokes, carbon black, and pyrolytic carbons.

Examples of the negative electrode current collector include Cu, Ni, and stainless steel. Among these materials, Cu is more preferable because Cu is not easily alloyed with lithium and is easily processed into a thin film.

Examples of a method for producing the negative electrode sheet include: a method in which the negative electrode active material is pressure-molded on the negative electrode current collector; and a method in which (i) the negative electrode active material is formed into a paste with use of an appropriate organic solvent, (ii) the negative electrode current collector is coated with the paste, and (iii) the paste is dried and then pressurized so that the paste is firmly fixed to the negative electrode current collector. The paste preferably contains the electrically conductive agent and the binding agent.

### <3.3. Nonaqueous Electrolyte>

A nonaqueous electrolyte is not limited to any particular one, provided that the nonaqueous electrolyte is one that is generally used for a nonaqueous electrolyte secondary battery such as a lithium ion secondary battery. The nonaqueous electrolyte can be, for example, a nonaqueous electrolyte containing an organic solvent and a lithium salt dissolved in the organic solvent. Examples of the lithium salt include LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salts, and LiAlCl₄. Only one of the above lithium salts may be used, or two or more of the above lithium salts may be used in combination.

Examples of the organic solvent to be contained in the nonaqueous electrolyte include carbonates, ethers, esters, nitriles, amides, carbamates, sulfur-containing compounds, and fluorine-containing organic solvents each obtained by introducing a fluorine group into any of these organic solvents. Only one of the above organic solvents may be used, or two or more of the above organic solvents may be used in combination.

### <3.4. Method for Producing Nonaqueous Electrolyte Secondary Battery>

The nonaqueous electrolyte secondary battery can be produced by a conventionally known method. For example, first, the material for a nonaqueous electrolyte secondary battery is formed by disposing the positive electrode, the above-described laminated separator, and the negative electrode in this order. Next, the material for a nonaqueous electrolyte secondary battery is put into a container which serves as a housing for the nonaqueous electrolyte secondary battery. Further, the container is filled with the nonaqueous electrolyte, and then hermetically sealed while pressure is reduced in the container. In this way, the nonaqueous electrolyte secondary battery can be produced.

The present invention is not limited to the embodiments, but can be altered by a skilled person in the art within the scope of the claims. The present invention also encompasses, in its technical scope, any embodiment derived by combining technical means disclosed in differing embodiments.

Embodiments of the present invention may include the following configurations.
<1-1> A laminated separator which is for a nonaqueous electrolyte secondary battery and which includes a polyolefin-based substrate and a heat-resistant layer that is provided on one surface or both surfaces of the polyolefin-based substrate, the laminated separator including a particle layer which is provided on at least one side of the laminated separator, a standard deviation of a 60-degree specular gloss on a surface of the laminated separator which surface is located on the at least one side on which the particle layer is provided being not more than 0.80.
<1-2> The laminated separator described in <1-1>, wherein a weight per unit area of the particle layer on one side of the laminated separator is not less than 0.01 g/m² and less than 0.2 g/m².
<1-3> The laminated separator described in <1-1> or <1-2>, wherein the heat-resistant layer contains an aromatic resin.
<1-4> The laminated separator described in <1-3>, wherein the aromatic resin is an aramid resin.
<1-5> A material for a nonaqueous electrolyte secondary battery, including a positive electrode, a laminated separator described in any one of <1-1> through <1-4>, and a negative electrode which are formed in this order.
<1-6> A nonaqueous electrolyte secondary battery including a laminated separator recited in any one of <1-1> through <1-4>.
<2-1> A laminated separator which is for a nonaqueous electrolyte secondary battery and which includes a polyolefin-based substrate and a heat-resistant layer that is provided on one surface or both surfaces of the polyolefin-based substrate, the laminated separator including a particle layer which is provided on at least one side of the laminated separator, a standard deviation of surface roughness on a surface of the laminated separator which surface is located on the at least one side on which the particle layer is provided being not more than 0.06.
<2-2> The laminated separator described in <2-1>, wherein a weight per unit area of the particle layer on one side of the laminated separator is not less than 0.01 g/m² and less than 0.2 g/m².
<2-3> The laminated separator described in <2-1> or <2-2>, wherein the heat-resistant layer contains an aromatic resin.
<2-4> The laminated separator described in <2-3>, wherein the aromatic resin is an aramid resin.
<2-5> A material for a nonaqueous electrolyte secondary battery, including a positive electrode, a laminated separator described in any one of <2-1> through <2-4>, and a negative electrode which are formed in this order.
<2-6> A nonaqueous electrolyte secondary battery including a laminated separator recited in any one of <2-1> through <2-4>.
<3-1> A laminated separator which is for a nonaqueous electrolyte secondary battery and which includes a polyolefin-based substrate and a heat-resistant layer that is provided on one surface or both surfaces of the polyolefin-based substrate, the laminated separator including a particle layer which is provided on at least one side of the laminated separator, a standard deviation of an IR peak intensity ratio on a surface of the laminated separator which surface is located on the at least one side on which the particle layer is provided being not more than 0.025, the IR peak intensity ratio being calculated from the following formula. IR peak intensity ratio=peak intensity which is of a resin contained in the particle layer and which is in an infrared absorption spectrum/peak intensity which is of a resin contained in the heat-resistant layer and which is in an infrared absorption spectrum
<3-2> The laminated separator described in <3-1>, wherein a weight per unit area of the particle layer on one side of the laminated separator is not less than 0.01 g/m² and less than 0.2 g/m².
<3-3> The laminated separator described in <3-1> or <3-2>, wherein the heat-resistant layer contains an aromatic resin.
<3-4> The laminated separator described in <3-3>, wherein the aromatic resin is an aramid resin.
<3-5> A material for a nonaqueous electrolyte secondary battery, including a positive electrode, a laminated separator described in any one of <3-1> through <3-4>, and a negative electrode which are formed in this order.
<3-6> A nonaqueous electrolyte secondary battery including a laminated separator recited in any one of <3-1> through <3-4>.
<4-1> A laminated separator which is for a nonaqueous electrolyte secondary battery and which includes a polyolefin-based substrate and a heat-resistant layer that is provided on one surface or both surfaces of the polyolefin-based substrate, the laminated separator including a particle layer which is provided on at least one side of the laminated separator, a product of a standard deviation of a 60-degree specular gloss and a standard deviation of surface roughness on a surface of the laminated separator which surface is located on the at least one side on which the particle layer is provided being not more than 0.06.
<4-2> The laminated separator described in <4-1>, wherein a weight per unit area of the particle layer on one side of the laminated separator is not less than 0.01 g/m² and less than 0.2 g/m².
<4-3> The laminated separator described in <4-1> or <4-2>, wherein the heat-resistant layer contains an aromatic resin.
<4-4> The laminated separator described in <4-3>, wherein the aromatic resin is an aramid resin.
<4-5> A material for a nonaqueous electrolyte secondary battery, including a positive electrode, a laminated separator described in any one of <4-1> through <4-4>, and a negative electrode which are formed in this order.
<4-6> A nonaqueous electrolyte secondary battery including a laminated separator recited in any one of <4-1> through <4-4>.
<5-1> A laminated separator which is for a nonaqueous electrolyte secondary battery and which includes a polyolefin-based substrate and a heat-resistant layer that is provided on one surface or both surfaces of the polyolefin-based substrate, the laminated separator including a particle layer which is provided on at least one side of the laminated separator, a product of a standard deviation of a 60-degree specular gloss and a standard deviation of an IR peak intensity ratio on a surface of the laminated separator which surface is located on the at least one side on which the particle layer is provided being not more than 0.016, the IR peak intensity ratio being calculated from the following formula. IR peak intensity ratio=peak intensity which is of a resin contained in the particle layer and which is in an infrared absorption spectrum/peak intensity which is of a resin contained in the heat-resistant layer and which is in an infrared absorption spectrum
<5-2> The laminated separator described in <5-1>, wherein a weight per unit area of the particle layer on one side of the laminated separator is not less than 0.01 g/m² and less than 0.2 g/m².
<5-3> The laminated separator described in <5-1> or <5-2>, wherein the heat-resistant layer contains an aromatic resin.
<5-4> The laminated separator described in <5-3>, wherein the aromatic resin is an aramid resin.
<5-5> A material for a nonaqueous electrolyte secondary battery, including a positive electrode, a laminated separator described in any one of <5-1> through <5-4>, and a negative electrode which are formed in this order.
<5-6> A nonaqueous electrolyte secondary battery including a laminated separator recited in any one of <5-1> through <5-4>.
<6-1> A laminated separator which is for a nonaqueous electrolyte secondary battery and which includes a polyolefin-based substrate and a heat-resistant layer that is provided on one surface or both surfaces of the polyolefin-based substrate, the laminated separator including a particle layer which is provided on at least one side of the laminated separator, a product of a standard deviation of surface roughness and a standard deviation of an IR peak intensity ratio on a surface of the laminated separator which surface is located on the at least one side on which the particle layer is provided being not more than 0.0016, the IR peak intensity ratio being calculated from the following formula. IR peak intensity ratio=peak intensity which is of a resin contained in the particle layer and which is in an infrared absorption spectrum/peak intensity which is of a resin contained in the heat-resistant layer and which is in an infrared absorption spectrum
<6-2> The laminated separator described in <6-1>, wherein a weight per unit area of the particle layer on one side of the laminated separator is not less than 0.01 g/m² and less than 0.2 g/m².
<6-3> The laminated separator described in <6-1> or <6-2>, wherein the heat-resistant layer contains an aromatic resin.
<6-4> The laminated separator described in <6-3>, wherein the aromatic resin is an aramid resin.
<6-5> A material for a nonaqueous electrolyte secondary battery, including a positive electrode, a laminated separator described in any one of <6-1> through <6-4>, and a negative electrode which are formed in this order.
<6-6> A nonaqueous electrolyte secondary battery including a laminated separator recited in any one of <6-1> through <6-4>.
<7-1> A laminated separator which is for a nonaqueous electrolyte secondary battery and which includes a polyolefin-based substrate and a heat-resistant layer that is provided on one surface or both surfaces of the polyolefin-based substrate, the laminated separator including a particle layer which is provided on at least one side of the laminated separator, a product of a standard deviation of a 60-degree specular gloss, a standard deviation of surface roughness, and a standard deviation of an IR peak intensity ratio on a surface of the laminated separator which surface is located on the at least one side on which the particle layer is provided being not more than 0.0015, the IR peak intensity ratio being calculated from the following formula. IR peak intensity ratio=peak intensity which is of a resin contained in the particle layer and which is in an infrared absorption spectrum/peak intensity which is of a resin contained in the heat-resistant layer and which is in an infrared absorption spectrum
<7-2> The laminated separator described in <7-1>, wherein a weight per unit area of the particle layer on one side of the laminated separator is not less than 0.01 g/m² and less than 0.2 g/m².
<7-3> The laminated separator described in <7-1> or <7-2>, wherein the heat-resistant layer contains an aromatic resin.
<7-4> The laminated separator described in <7-3>, wherein the aromatic resin is an aramid resin.
<7-5> A material for a nonaqueous electrolyte secondary battery, including a positive electrode, a laminated separator described in any one of <7-1> through <7-4>, and a negative electrode which are formed in this order.
<7-6> A nonaqueous electrolyte secondary battery including a laminated separator recited in any one of <7-1> through <7-4>.

### EXAMPLES

The following description will discuss examples of the present invention.

### [Measurement of Gloss]

In conformity with JIS Z8741, measured as follows were a specular gloss under a condition that a light-incident angle and a light-receiving angle were each 60 degrees (60-degree gloss) and a specular gloss under a condition that a light-incident angle and a light-receiving angle were each 85 degrees (85-degree gloss).

A laminated separator described in each of examples and comparative example was cut into an A4 size. One sheet of KB paper (manufactured by KOKUYO Co., Ltd., product number: KB-39N) was placed as a base, and then the A4-sized laminated separator was placed thereon. A handy-type e glossmeter (manufactured by NIPPON DENSHOKU INDUSTRIES Co., Ltd., model: PG-IIM, measurement range: 10.0 mm×20.0 mm) was used to measure the specular gloss of a surface of a particle layer of the laminated separator.

The measurement was carried out 10 times at arbitrary points per sample. With use of 10 measured values thus obtained, the average value of the gloss was calculated. Subsequently, the 10 measured values and the average value were used to calculate the standard deviation of the gloss. Note that, as the standard deviation of the gloss, a value obtained by rounding off the calculated standard deviation to two decimal places was used below. The measurement was also carried out on a surface of a heat-resistant layer of the laminated separator before formation of the particle layer.

### [Measurement of Surface Roughness]

As a non-contact-type surface roughness measurement apparatus, “LEXT 3D MEASURING LASER MICROSCOPE OLS 4100” manufactured by OLYMPUS Corporation was used. Note that measurement conditions were as follows.
Objective lens: 50 times
Wavelength filter: 405 nm
Image capturing: After focus was adjusted in color image capturing, the upper limit and the lower limit of brightness in a thickness direction were adjusted manually under laser observation, and then image capturing was carried out.
Measurement: Surface roughness was calculated after a tilt correction was carried out in an image correction.
Cut-off: None

A specific method for calculating the surface roughness was as follows. First, one-dimensional surface roughness Sa for a length of 250 μm was obtained from two-dimensional data obtained at one point on the particle layer. Subsequently, this operation was repeated at 10 randomly extracted points on the particle layer. With use of 10 measured values thus obtained, the average value of the surface roughness was calculated. Then, the 10 measured values and the average value were used to calculate the standard deviation of the surface roughness. Note that, as the standard deviation of the surface roughness, a value obtained by rounding off the calculated standard deviation to three decimal places was used below. The measurement was also carried out on the surface of the heat-resistant layer of the laminated separator before formation of the particle layer.

### [Attenuated Total Reflection Infrared Spectroscopy (ATR-IR)]

With respect to the laminated separator produced in each of the examples and the comparative example, an “IR peak intensity ratio” was calculated by a method including the following steps (I) to (III).

(I) The surface of the particle layer formed on the heat-resistant layer was set as a measurement target. With use of a reflection type infrared analyzer (manufactured by Agilent Technologies, Inc., product name: Cary 660 FTIR), attenuated total reflection infrared spectroscopy was carried out with respect to the measurement target under the following <Measurement condition> to obtain an infrared absorption spectrum (IR spectrum).

### <Measurement Condition>

Measurement was carried out by an ATR method with use of diamond as a prism in a nitrogen atmosphere.

(II) From the IR spectrum obtained in the step (I), the peak intensity (A) of a peak indicating a heat-resistant resin and the peak intensity (B) of a peak indicating an acrylic resin contained in the particle layer or the peak intensity (C) of a peak indicating a PVDF resin contained in the particle layer were obtained.

(III) With use of the peak intensities (A), (B) and (C) obtained in the step (II), the “IR peak intensity ratio” was calculated based on the following formulas (2) and (3).

“IR peak intensity ratio”=peak intensity (B)/peak intensity (A) formula (2)

“IR peak intensity ratio”=peak intensity (C)/peak intensity (A) formula (3)

Note that, as described later, in the laminated separator produced in each of Examples 1 and 2 and Comparative Example 1, an aramid resin was used as the heat-resistant resin, and an organic compound particles made of a styrene-acrylic cross-linked polymer compound, which is an acrylic resin, were used as particles. Note also that, in the laminated separator produced in Example 3, an aramid resin was used as the heat-resistant resin, and PVDF resin particles were used as particles.

Therefore, a peak that was present in the wave number range of 1,620 cm⁻¹ to 1,700 cm⁻¹ in the IR spectrum obtained in the step (I) is the peak indicating the heat-resistant resin. Thus, in the step (II), the intensity of the peak that was present in the wave number range of 1,620 cm⁻¹ to 1,700 cm⁻¹ was measured and regarded as the peak intensity (A). A peak that was present in the wave number range of 1,700 cm⁻¹ to 1,900 cm⁻¹ is the peak indicating the acrylic resin. Thus, the intensity of the peak that was present in the wave number range of 1,700 cm⁻¹ to 1,900 cm⁻¹ was measured and regarded as the peak intensity (B). Alternatively, a peak that was present in the wave number range of 1,000 cm⁻¹ to 1,100 cm⁻¹ is the peak indicating the PVDF resin. Thus, the intensity of the peak that was present in the wave number range of 1,000 cm⁻¹ to 1,100 cm⁻¹ was measured and regarded as the peak intensity (C).

The steps (I) to (III) were carried out 10 times at arbitrary points per sample. With use of 10 measured values thus obtained, the average value of the IR peak intensity ratio was calculated. Subsequently, the 10 measured values and the average value were used to calculate the standard deviation of the IR peak intensity ratio. Note that, as the standard deviation of the IR peak intensity ratio, a value obtained by rounding off the calculated standard deviation to three decimal places was used below. Note also that measurement of the peak intensity of the peak indicating the heat-resistant resin and calculation of the standard deviation of the peak intensity were carried out also on the surface of the heat-resistant layer of the laminated separator before formation of the particle layer.

[Measurement of 3 C Discharge Capacity Retention Rate after Pressurization]

First, a nonaqueous electrolyte secondary battery for a test in which the laminated separator described in each of the examples and the comparative example was incorporated was prepared by the following procedure.
1. A positive electrode was prepared. The positive electrode had a thickness of 49.9 μm, a density of 2.97 g/cm³, and a void volume of 24.4 μL. A positive electrode active material layer was composed of LiNi_{0.78}Co_{0.19}Al_{0.03}O₂, an electrically conductive agent, and polyvinylidene fluoride at a weight ratio of 92:4:4.
2. A negative electrode was prepared. The negative electrode had a thickness of 71.2 μm, a density of 1.45 g/cm³, and a void volume of 41.3 μL. A negative electrode active material layer was composed of artificial graphite, styrene butadiene rubber, and carboxymethyl cellulose at a weight ratio of 96.5:2.0:1.5.
3. A material for a nonaqueous electrolyte secondary battery was prepared by forming the negative electrode, the laminated separator, and the positive electrode in this order.
4. The material for a nonaqueous electrolyte secondary battery was stored in a bag which was made up of an aluminum layer and a heat-sealing layer that was formed on the aluminum layer, and a nonaqueous electrolyte was injected into the bag. The amount of the nonaqueous electrolyte injected was set to be 2.8 times the total void volume of the electrodes and the laminated separator. The nonaqueous electrolyte was obtained by dissolving vinylene carbonate and LiPF₆ in a mixed solvent containing ethylene carbonate, ethyl methyl carbonate, and diethyl carbonate at 3:5:2 (volume ratio) so that the concentration of the vinylene carbonate became 1% by weight and the concentration of the LiPF₆ became 1 mol/L.
5. The bag was heat-sealed while pressure inside the bag was reduced. In this way, the nonaqueous electrolyte secondary battery for a test was prepared.

Next, a 3 C discharge capacity retention rate after pressurization at 30 MPa was measured by the following procedure.
1. The first cycle of charge and discharge was carried out under a condition that a temperature was 25° C., a voltage range was 2.7 V to 4.2 V, and current values were 0.1 C (charge) and 0.2 C (discharge). Note, here, that 1 C is a current value at which a battery rated capacity derived from a one-hour rate discharge capacity is discharged in one hour.
2. Ten cycles of charge and discharge were carried out under a condition that the temperature was 25° C., the voltage range was 2.7 V to 4.2 V, and the current values were 1 C (charge) and 5 C (discharge) so that the nonaqueous electrolyte secondary battery was aged.
3. After the nonaqueous electrolyte secondary battery was charged to 4.2 V under a condition that the temperature was 25° C. and the current value was 1 C, the nonaqueous electrolyte secondary battery was sandwiched between two SUS plates, and pressure of 30 MPa was applied by a pressing machine. Then, four corners of the SUS plates were fixed in a state where the pressure was applied, and the pressure by the pressing machine was released.
4. One cycle of charge and discharge was carried out under a condition that the temperature was 25° C., the voltage range was 2.7 V to 4.2 V, and the current values were 0.1 C (charge) and 0.2 C (discharge). A discharge capacity (mAh) at this time was defined as a 0.2 C capacity after pressurization.
5. One cycle of charge and discharge was carried out under a condition that the temperature was 25° C., the voltage range was 2.5 V to 4.2 V, and the current values were 1 C (charge) and 3 C (discharge). A discharge capacity (mAh) at this time was defined as a 3 C capacity after pressurization.
6. The 3C capacity after pressurization was divided by the 0.2 C capacity after pressurization, and a value thus obtained was expressed in percentage. A value thus obtained was defined as the 3 C discharge capacity retention rate after pressurization.

### [Soldering Iron Test]

1. The laminated separator prepared in each of the examples and the comparative example was cut into 3.0 cm×5.0 cm.
2. A positive electrode of 3.0 cm×5.0 cm was prepared. The positive electrode had a thickness of 49.9 μm, a density of 2.97 g/cm³, and a void volume of 24.4 μL. A positive electrode active material layer was composed of LiNi_{0.78}Co_{0.19}Al_{0.03}O₂, an electrically conductive agent, and polyvinylidene fluoride at a weight ratio of 92:4:4.
3. The laminated separator and the positive electrode were thermally pressed at 60° C. and 1 MPa for 6 seconds to prepare a laminated body in which the laminated separator and the positive electrode were bonded to each other.
4. A metal stick having a temperature of 450° C. and a diameter of 2.2 mm was passed through the laminated body from the laminated separator side of the laminated body with use of a solder test device. Time from when a tip portion of the metal stick was brought into contact with a surface of the laminated separator to when the tip portion was separated from the surface was 3 seconds. After the test was ended, the area of an opening in the laminated body was determined. The area of the opening was measured with use of a digital microscope VHX-5000 manufactured by Keyence Corporation and image analysis software attached thereto.

### Example Production of Aramid Polymerization Solution

Poly(paraphenylene terephthalamide) was produced with use of a 3-liter separable flask having a stirring blade, a thermometer, a nitrogen inlet pipe, and a powder addition port.

The flask was sufficiently dried, 2,200 g of N-methyl-2-pyrrolidone (NMP) was charged, and then 151.07 g of a calcium chloride powder was added. The calcium chloride powder was added after vacuum drying at 200° C. for 2 hours. The temperature of the NMP was increased to 100° C. so that the calcium chloride powder was completely dissolved. After the temperature of a solution thus obtained was returned to room temperature, 68.23 g of paraphenylenediamine was added, and the paraphenylenediamine was completely dissolved. While the temperature of a solution thus obtained was maintained at 20° C.±2° C. and a dissolved oxygen concentration during polymerization was maintained at 0.5%, 124.97 g of terephthalic acid dichloride was added, to the solution, in 10 portions at approximately 5-minute intervals. Thereafter, while the temperature of the solution was maintained at 20° C.±2° C., the solution was aged for 1 hour while being stirred. Subsequently, the solution thus aged was filtrated through a 1500-mesh stainless steel gauze. A resultant solution was a para-aramid solution having a para-aramid concentration of 6%.

### Example 1

In a flask, 100 g of the para-aramid solution that had been obtained in the above [Production example of aramid polymerization liquid] was weighed out. Then, 166.7 g of NMP was added so that the para-aramid solution having a para-aramid concentration of 2.25% by weight was prepared. This solution was stirred for 60 minutes. Subsequently, 6.0 g of Alumina C (manufactured by Nippon Aerosil Co., Ltd.) was mixed with the solution, and then stirring was carried out for 240 minutes. A solution thus obtained was filtrated through a 1000-mesh wire gauze. Then, 0.73 g of calcium carbonate was added and stirring was carried out for 240 minutes so that the solution was neutralized. Further, defoaming was carried out under reduced pressure, so that a coating solution (1) was prepared.

The coating solution (1) was applied, by a doctor blade method, to both surfaces of a substrate (thickness: 9.2 μm, porosity: 53%) made of polyethylene so that the weight per unit area of a heat-resistant layer on one side was 1.0 g/m². A resultant coated material (1) was left to stand still in the air at 50° C. and a relative humidity of 70% for 1 minute so that layers containing poly(paraphenylene terephthalamide) were deposited. Next, the coated material (1) was immersed in ion-exchange water so that calcium chloride and the solvent were removed. Thereafter, the coated material (1) was dried in an oven at 80° C., and a heat-resistant separator (1) was obtained in which aramid heat-resistant layers were formed on the substrate.

Subsequently, organic compound particles made of a styrene-acrylic cross-linked polymer compound having an average particle diameter of 0.65 μm (BM-2570M, manufactured by Zeon Corporation) and ultrapure water as a solvent were mixed at a weight ratio of 4:96, so that a homogeneous slurry (1) was obtained.

Next, while the slurry (1) was stirred at a stirring speed of 150 rpm in a stirred tank, the slurry (1) was supplied from the stirred tank to a coater at a speed of 2,000 mL/min, and applied to both surfaces of the heat-resistant separator (1) with use of the coater so that the weight per unit area of a particle layer on one side was 0.09 g/m². After the application, the slurry (1) was dried at 50° C. in a dryer, so that a laminated separator (1) was obtained.

### Example 2

A laminated separator (2) was obtained by carrying out an operation similar to that in Example 1, except that organic compound particles made of a styrene-acrylic cross-linked polymer compound having an average particle diameter of 0.50 μm (BM-2530M, manufactured by Zeon Corporation) was used as particles contained in each particle layer.

### Example 3

A laminated separator (3) was obtained by carrying out an operation similar to that in Example 1, except that particles made of a polyvinylidene fluoride resin having an average particle diameter of 0.25 μm (Solef2042, manufactured by Solvey) were used as particles contained in each particle layer.

### Example 4

A coating solution (4) was prepared by the following procedure. An aramid resin contained in the coating solution (4) was a block copolymer having a poly(4,4′-diphenylsulfonyl terephthalamide) block.
1. A 5-liter separable flask having a stirring blade, a thermometer, a nitrogen inlet pipe, and a powder addition port was sufficiently dried.
2. Into the flask, 4,241 g of NMP was introduced. Furthermore, 326.1 g of calcium chloride was added into the flask, and the temperature of a resultant mixture was increased to 100° C. In this way, the calcium chloride was completely dissolved, and an NMP solution of the calcium chloride (7.14% by weight) was obtained. Then, water was added so that the water content of the NMP solution of the calcium chloride was adjusted to 450 ppm. The calcium chloride dissolved in the NMP was one that had been subjected to vacuum drying at 200° C. for 2 hours in advance.
3. In a state where the temperature of a polymerization system was maintained at 40° C., 141.70 g of 4,4′-diaminodiphenylsulfone (DDS) was added and completely dissolved.
4. The temperature of the polymerization system was decreased to 25° C. In a state where the temperature of the polymerization system was maintained at 25±2° C., 115.86 g of terephthalic acid dichloride (TPC) in total was added in three portions. By a reaction for 1 hour, a block A which was constituted by poly(4,4′-diphenylsulfonyl terephthalamide) was synthesized. In the block A, the molar ratio of DDS to TPC was 1.00.
5. Into the flask, 61.71 g of paraphenylenediamine (PPD) was added and completely dissolved in 1 hour.
6. In a state where the temperature of the polymerization system was maintained at 25±2° C., 113.03 g of TPC in total was added in three portions. By a reaction for 1.5 hours, a block B which was constituted by poly(paraphenylene terephthalamide) was caused to extend on both sides of the block A. In the block B, the molar ratio of PPD to TPC was 1.025.
7. In a state where the temperature of the polymerization system was maintained at 20±2° C., aging was carried out for 1 hour. In this way, an aramid polymerization solution (4) was obtained. In a block copolymer contained in the aramid polymerization liquid (4), the block A accounted for 50% of the whole molecule, and the block B accounted for the remaining 50% of the whole molecule.
8. Alumina (average particle diameter: 13 nm) was added to and mixed with the aramid polymerization liquid (4). In so doing, the alumina was added so that the weight ratio between an aramid resin and the alumina became 1:1.
9. NMP and calcium carbonate were added to a mixed solution obtained in the above step 8 as a diluent and a neutralizer, respectively, so that a solid content became 4% by weight. Note, here, that the “solid content” indicates a proportion of the aramid resin and the alumina contained. This solution was stirred for 20 minutes so as to be diluted and neutralized. This neutralization solution was defoamed under reduced pressure to prepare the coating solution (4) in a slurry state.

The coating solution (4) was applied, by a doctor blade method, to both surfaces of a substrate (thickness: 8.9 μm, porosity: 46%) made of polyethylene so that the weight per unit area of a heat-resistant layer on one side was 1.0 g/m². A resultant coated material (4) was left to stand still in the air at 50° C. and a relative humidity of 70% for 1 minute so that layers containing the block copolymer having the poly(4,4′-diphenylsulfonyl terephthalamide) block were deposited. Next, the coated material (4) was immersed in ion-exchange water so that the calcium chloride and the solvent were removed. Thereafter, the coated material (4) was dried in an oven at 80° C., and a heat-resistant separator (4) was obtained in which aramid heat-resistant layers were formed on the substrate.

Subsequently, particle layers were formed by carrying out an operation similar to that in Example 1, so that a laminated separator (4) was obtained.

### Comparative Example 1

A laminated separator (5) was obtained by carrying out an operation similar to that in Example 1, except that coating with the slurry (1) was carried out without stirring in a stirred tank.

### [Evaluation Results]

Evaluation results are shown in Tables 1 and 2.

TABLE 1

| | Heat-resistant layer | | | | | |
|---|---|---|---|---|---|---|
| | Weight | Average | Standard deviation | | | |
| | per unit | value | | | Surface | |
| | area | 85-degree | 85-degree | 60-degree | roughness | IR peak |
| | [g/m²] | gloss | gloss | gloss | Sa | intensity |
| Example 1 | 2.0 | 23.85 | 1.82 | 0.59 | 0.043 | 0.0055 |
| Example 2 | | 23.85 | 1.82 | 0.59 | 0.043 | 0.0055 |
| Example 3 | | 23.85 | 1.82 | 0.59 | 0.043 | 0.0055 |
| Example 4 | | 20.90 | 2.50 | 0.30 | 0.034 | — |
| Comparative | | 23.85 | 1.82 | 0.59 | 0.043 | 0.0055 |
| Example 1 | | | | | | |

TABLE 2

| | Particle layer | | | | | | |
|---|---|---|---|---|---|---|---|
| | Weight | | Average | Standard deviation | | | |
| | per unit | | value | | | Surface | IR peak |
| | area | Application | 85-degree | 85-degree | 60-degree | roughness | intensity |
| | [g/m²] | method | gloss | gloss | gloss | Sa | ratio |
| Example 1 | 0.09 | Stirred | 22.94 | 1.18 | 0.31 | 0.028 | 0.003 |
| Example 2 | 0.09 | | 23.79 | 1.84 | 0.44 | 0.028 | 0.018 |
| Example 3 | 0.11 | | 25.63 | 2.41 | 0.78 | 0.019 | 0.011 |
| Example 4 | 0.09 | | 19.05 | 2.70 | 0.20 | 0.020 | — |
| Comparative | 0.09 | Not stirred | 31.29 | 3.36 | 0.90 | 0.114 | 0.030 |
| Example 1 | | | | | | | |

| | Particle layer | | | | | |
|---|---|---|---|---|---|---|
| | Product of standard deviations | | | | | |
| | | | | 60-degree | | |
| | | | | gloss × | 3 C discharge | |
| | | 60-degree | Surface | Surface | capacity | |
| | 60-degree | gloss × | roughness × | roughness × | retention rate | Result of |
| | gloss × | IR peak | IR peak | IR peak | after | soldering |
| | Surface | intensity | intensity | intensity | pressurization | iron test |
| | roughness | ratio | ratio | ratio | [%] | [mm²] |
| Example 1 | 0.00856 | 0.00081 | 0.000074 | 0.0000226 | 66 | 1.71 |
| Example 2 | 0.01246 | 0.00811 | 0.000524 | 0.0002302 | 66 | 1.72 |
| Example 3 | 0.01504 | 0.00840 | 0.000207 | 0.0001617 | 63 | 1.99 |
| Example 4 | 0.0395 | — | — | — | 69 | 1.93 |
| Comparative | 0.1030 | 0.0268 | 0.00337 | 0.0030453 | 58 | 2.14 |
| Example 1 | | | | | | |

In Examples 1 to 4 in each of which the standard deviation of a 60-degree gloss was not more than 0.80, a 3 C discharge capacity retention rate after pressurization was high, and the area of an opening which was obtained by the soldering iron test was small, as compared with Comparative Example 1 in which the standard deviation of a 60-degree gloss exceeded 0.80. From these results, it can be said that, in Examples 1 to 4 as compared with Comparative Example 1, it was possible to obtain a laminated separator which was for a nonaqueous electrolyte secondary battery and which made it possible to obtain a battery having an excellent rate characteristic and which had excellent heat resistance.

It can be said that, in Examples 1 to 4 in each of which the standard deviation of surface roughness was not more than 0.06, the 3 C discharge capacity retention rate after pressurization was high, and the area of the opening which was obtained by the soldering iron test was small, as compared with Comparative Example 1 in which the standard deviation of surface roughness exceeded 0.06.

It can be said that, in Examples 1 to 3 in each of which the standard deviation of an IR peak intensity ratio was not more than 0.025, the 3 C discharge capacity retention rate after pressurization was high, and the area of the opening which was obtained by the soldering iron test was small, as compared with Comparative Example 1 in which the standard deviation of an IR peak intensity ratio exceeded 0.025.

It can be said that, in Examples 1 to 4 in each of which the product of the standard deviation of the 60-degree gloss and the standard deviation of the surface roughness was not more than 0.06, the 3 C discharge capacity retention rate after pressurization was high, and the area of the opening which was obtained by the soldering iron test was small, as compared with Comparative Example 1 in which the product of the standard deviation of the 60-degree gloss and the standard deviation of the surface roughness exceeded 0.06.

It can be said that, in Examples 1 to 3 in each of which the product of the standard deviation of the 60-degree gloss and the standard deviation of the IR peak intensity ratio was not more than 0.016, the 3 C discharge capacity retention rate after pressurization was high, and the area of the opening which was obtained by the soldering iron test was small, as compared with Comparative Example 1 in which the product of the standard deviation of the 60-degree gloss and the standard deviation of the IR peak intensity ratio exceeded 0.016.

It can be said that, in Examples 1 to 3 in each of which the product of the standard deviation of the surface roughness and the standard deviation of the IR peak intensity ratio was not more than 0.0016, the 3 C discharge capacity retention rate after pressurization was high, and the area of the opening which was obtained by the soldering iron test was small, as compared with Comparative Example 1 in which the product of the standard deviation of the surface roughness and the standard deviation of the IR peak intensity ratio exceeded 0.0016.

It can be said that, in Examples 1 to 3 in each of which the product of the standard deviation of the 60-degree gloss, the standard deviation of the surface roughness, and the standard deviation of the IR peak intensity ratio was not more than 0.0015, the 3 C discharge capacity retention rate after pressurization was high, and the area of the opening which was obtained by the soldering iron test was small, as compared with Comparative Example 1 in which the product of the standard deviation of the 60-degree gloss, the standard deviation of the surface roughness, and the standard deviation of the IR peak intensity ratio exceeded 0.0015.

The laminated separators in Examples 1 to 3 were each obtained by applying the slurry which had been supplied at a given speed while being stirred and thereby forming the particle layers. There was no difference among Examples 1 to 3 and Comparative Example 1 in terms of the standard deviation of each parameter on the surfaces of the heat-resistant layers before formation of the particle layers. Therefore, it is considered that a difference in the method for forming the particle layers among Examples 1 to 3 and Comparative Example 1 caused a difference in the standard deviation of each parameter on the particle layers and accordingly caused a difference in the effect. Also in Example 4, by forming the particle layers by the method similar to those in Examples 1 to 3, an excellent effect was achieved as compared with that achieved in Comparative Example 1.

### INDUSTRIAL APPLICABILITY

An aspect of the present invention can be used for a nonaqueous electrolyte secondary battery.

### REFERENCE SIGNS LIST

1 Polyolefin-based substrate
2, 2a, 2b Heat-resistant layer
3, 3a, 3b Particle layer
4a, 4b, 4c, 4d, 4c Laminated separator

1. A laminated separator which is for a nonaqueous electrolyte secondary battery and which includes a polyolefin-based substrate and a heat-resistant layer that is provided on one surface or both surfaces of the polyolefin-based substrate,
the laminated separator comprising a particle layer which is provided on at least one side of the laminated separator,
a standard deviation of surface roughness on a surface of the laminated separator which surface is located on the at least one side on which the particle layer is provided being not more than 0.06.

2. The laminated separator of claim 1, wherein a weight per unit area of the particle layer on one side of the laminated separator is not less than 0.01 g/m² and less than 0.2 g/m².

3. The laminated separator of claim 1, wherein the heat-resistant layer contains an aromatic resin.

4. The laminated separator of claim 3, wherein the aromatic resin is an aramid resin.

5. A material for a nonaqueous electrolyte secondary battery, comprising a positive electrode, a laminated separator recited in claim 1, and a negative electrode which are formed in this order.

6. A nonaqueous electrolyte secondary battery comprising a laminated separator recited in claim 1.
